(19) United States
(12) Patent Application Publication
(10) Pub. No.: US 2003/0076672 A1
(43) Pub. Date: Apr. 24, 2003

(54) Illuminated drink holder

(76) Inventor: Hayden Head, Branson, MO (US)

Correspondence Address: The Law Offices of William W. Cochran, LLC, Suite 230, 3555 Stanford Road, Fort Collins, CO, 80525, US

(21) Appl. No.: 10/274,660

(22) Filed: Oct. 18, 2002

Related U.S. Application Data
(60) Provisional application No. 60/335,422, filed on Oct. 23, 2001.

(51) Int. Cl. B65D 90/12; F21V 33/00

(52) U.S. Cl. 362/101; 215/376; 220/605

(57) ABSTRACT

A device for the illumination of a beverage container attaches securely to the bottom of the container and illuminates the beverage inside the container. The device is removable and reusable to be attached to another container when the first is empty. The activation of the light may be through mechanical switches, sensors, and other methods.

### CROSS REFERENCE TO RELATED APPLICATION

The present application claims priority to U.S. Provisional Patent Application serial No. 60/335,422 entitled “Illuminated Drink Holder” by Hayden Head, filed Oct. 23, 2001, the entirety of which is hereby specifically incorporated by reference for all it discloses and teaches.

### BACKGROUND OF THE INVENTION

a. Field of the Invention

The present invention pertains generally to beverage holders and specifically to a lighted attachment to a beverage holder.

b. Description of the Background

Beverages designed for children are generally designed for the children's enjoyment and entertainment. Typically, children's beverages are brightly colored, have sweet fruity tastes, and may be served in individual containers. Enhancing the drinking experience includes the visual aspects of the beverage and container. Often, the color and labeling of the container is limited to the color of the juice and any color printed matter that may thereupon be applied. Any eye catching device or novel item that may be incorporated into the packaging, or device that may be sold as a separate item to add to the novelty and excitement of consuming a beverage.

It would therefore be valuable to provide a method to further enhance the eye-catching appeal of a beverage container, both as packaged and during use. Further, such an enhancement may encourage consumers to purchase beverages in containers designed to work with the enhancements.

### SUMMARY OF THE INVENTION

The present invention overcomes the disadvantages and limitations of the prior art by providing a light designed to illuminate the liquid contents of a beverage container, both while the container is resting on a surface and while the beverage is being consumed. Further, the present invention is reusable, capable of being used over and over with multiple beverage containers.

The present invention may therefore comprise a device for the illumination of at least a portion of the contents of a beverage container comprising: a receiver adapted to accept a beverage container, the receiver being adapted to attach to the container and being further adapted to be removable; and a light source, the light source comprising a battery, a switch, and a light bulb.

### BRIEF DESCRIPTION OF THE DRAWINGS

In the drawings,

FIG. 1 is an illustration of an embodiment of the present invention for the illumination of a children's beverage container.

FIG. 2 is a cross-section view of the embodiment of FIG. 1.

FIG. 3 is a schematic diagram of the electrical circuitry of an embodiment of the present invention.

FIG. 4 is an illustration of another embodiment of the present invention for the illumination of a plastic soft drink bottle.

FIG. 5 is an illustration of yet another embodiment of the present invention for the illumination of a plastic soft drink bottle wherein the invention attaches to a bottle by a twisting motion.

FIG. 6 is an illustration of a cross section of another embodiment of the present invention for the illumination of a plastic soft drink bottle wherein the invention attaches to a bottle by grasping a center portion of the bottle.

### DETAILED DESCRIPTION OF THE INVENTION

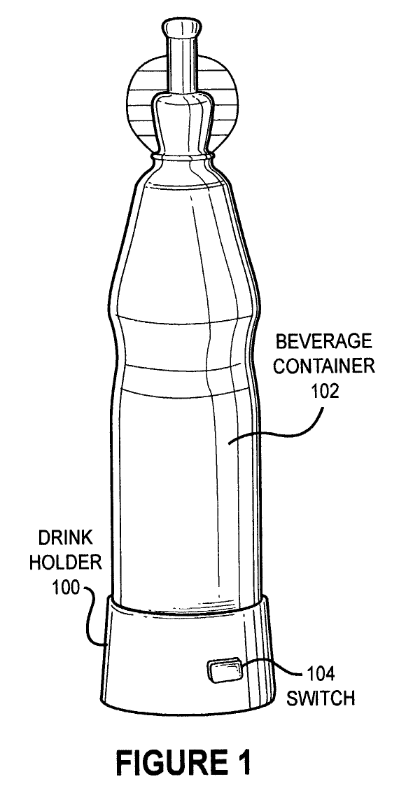

FIG. 1 is an illustration of an embodiment 100 of the present invention for the illumination of a children's beverage container 102. The beverage holder 100 is shown attached to the bottom of beverage container 102. A switch 104 may be activated to illuminate the beverage inside the container 102.

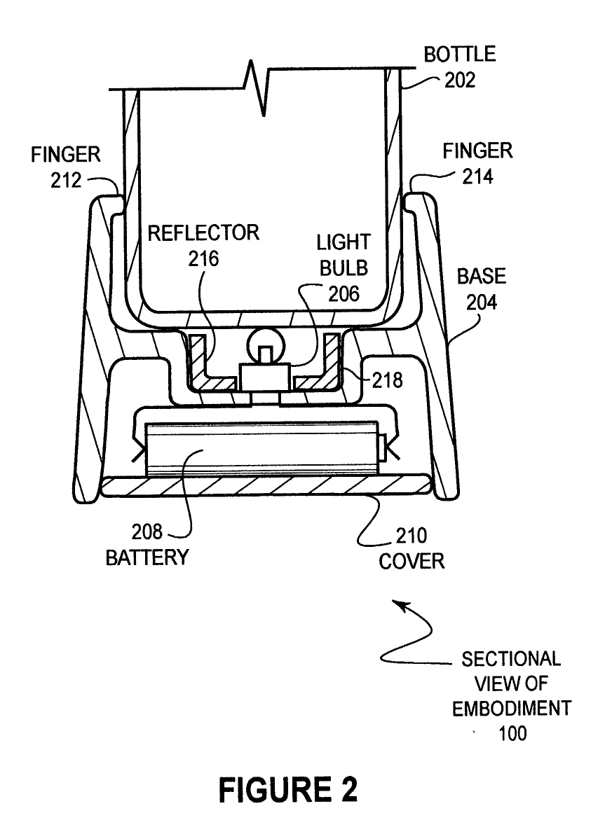

FIG. 2 is an illustration of a section view of embodiment 100. Bottle 202 is shown nestled into base 204. A light bulb 206 rests beneath the bottle 202 and provides the illumination of the beverage inside the bottle 202. A battery 208 provides the electrical energy for the light bulb 206. A cover 210 holds the battery 208 in place.

The bottle 202 may be any beverage container that is at least partially transparent. Such containers include carbonated soft drink containers, non-carbonated juice containers, plastic cups, or other drink receptacles. The cross-sectional shape of the containers may be round, square, elliptical, or other shape as desired.

The base 204 may engage the bottle 202 through various mechanisms, friction, snap fit, twist on, adhesive, or other mechanical engagement. For example, the fingers 212 and 214 may be constructed so that they are forced apart when the bottle 202 is inserted into the base 204. The frictional engagement between the fingers 212 and 214 and the bottle 202 may be sufficient to keep the embodiment 100 engaged to the bottle 202. In another example, the fingers 212 and 214 may be constructed so that the fingers 212 and 214 engage special features in bottle 202 when the bottle is properly inserted. The special features may be specifically designed to accept the fingers 212 and 214 or the features may be other decorative elements on the bottle 202. In another example, the base 204 may engage a threaded feature on the bottle 202 and twist onto the bottle 202 securely. The threaded feature may further include a locking mechanism. In another example, the base 204 may engage the bottle 202 with an adhesive that allows the base 204 to engage securely but also to be removed and reapplied to a second bottle 202. The base 204 engages the bottle 202 with enough strength that the base 204 stays on the bottle 202 while the beverage is being consumed. Other mechanical devices that afford the ability to secure the base 202 to a bottle 204 and remain removable and replaceable may be created by those skilled in the art while remaining within the spirit of the present invention.

The illumination of the beverage in bottle 202 is accomplished by the light bulb 206 operating such that the light is directed toward the bottom of the bottle 202. The base 204 encapsulates the bottom of the bottle 202 and directs the light from the bulb towards the bottle 202. The base 204 may be constructed of plastic that may be opaque or translucent. A translucent base 204 may allow some of the light from light bulb 206 to radiate through the base 204 and add to the visual appeal of the invention. In other embodiments, a reflector 216 may be added around the light bulb 206 to direct as much light as possible to the interior of the bottle 202. In other embodiments, the base 204 may be coated in the area 218 near the light bulb 206 as a reflective element. The base 204 may encircle the bottle 202 partially or completely to direct the light towards the interior of the bottle 202. In some embodiments, the base 204 may not engage the exterior of the bottle 202, but may engage a feature such as a recess in the bottom of bottle 202. Such embodiments may have other mechanisms, such as multiple light bulbs, for directing at least a portion of light into the bottom of the bottle 202.

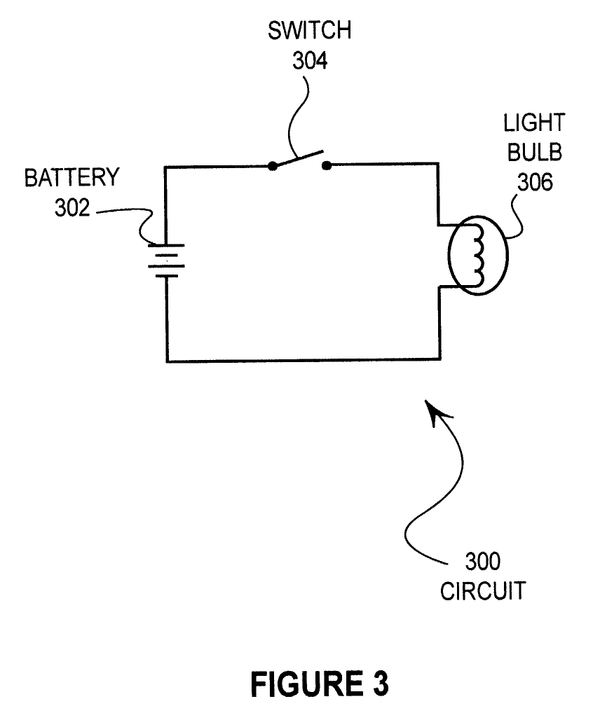

FIG. 3 is an illustration of a circuit diagram of an electrical circuit that may be used with the embodiment 100 of the present invention. A battery 302 is connected in series to a switch 304 and a light bulb 306.

The battery 302 may be any type of electrical energy storage, such as a conventional AA sized battery, a watch-type pancake battery, or any other battery type. In some embodiments, a rechargeable battery and system for recharging may be incorporated. Solar powered recharging system or other external power supplies may be used for recharging a rechargeable battery.

The switch 304 may be mounted as shown in item 104 in FIG. 1. In such a configuration, the user may press the switch 304 to illuminate the light. In other embodiments, the switch 304 may be a latching switch wherein the user presses the switch once to illuminate, then must press the switch again to turn off the light.

In other embodiments, the switch may be activated by the insertion of the bottle 202 into the base 204. In other embodiments, the switch may be a sensor and circuitry that activates in the absence of light, or some other sensor and circuitry. In still other embodiments, the light may be activated by a series of switches and circuits, such as a first switch that is mechanically activated by the user in series with a second switch that senses that a bottle is inserted into the device. Those skilled in the arts may create other methods of turning the illumination on and off while still maintaining within the spirit of the present invention.

The light bulb 306 may be any electrical device that generates light. This may include incandescent bulbs, fluorescent bulbs, Light Emitting Diodes (LED), lasers, or any other light generating device. The light bulb 306 may be a single light bulb or several light bulbs in series or parallel. Further, the light bulb may generate light in any color and may be used with several lights to generate various illumination effects. Circuitry may be added to cause the lights to flash, operate in sequence, respond to sound input, or otherwise be manipulated to change in a predetermined or random fashion.

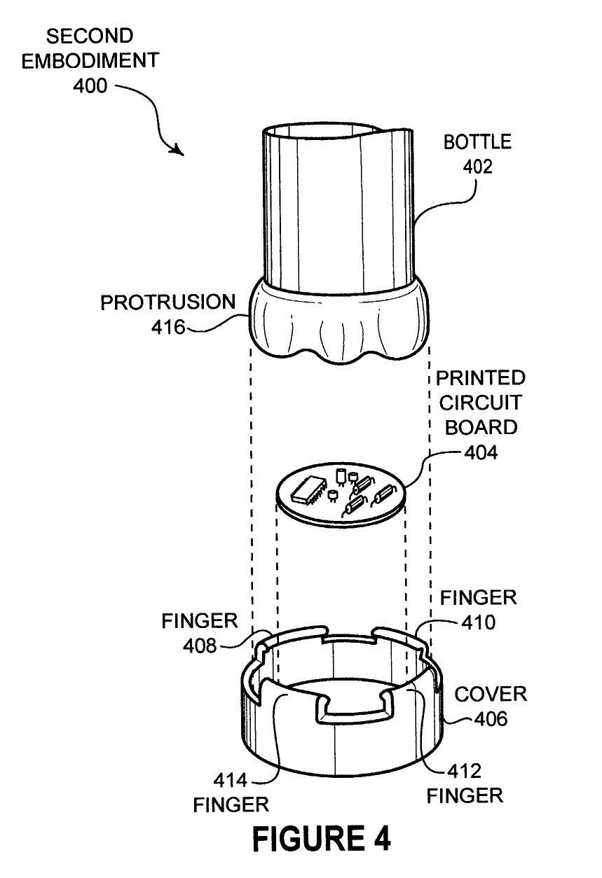

FIG. 4 illustrates an exploded perspective view of second embodiment 400 of the present invention wherein the bottle 402 is illuminated by a printed circuit board 404 that is held to the bottle 402 by a cover 406. The printed circuit board 404 may be permanently attached to cover 406. Such an embodiment may be low enough cost to be made in high volume.

The printed circuit board 404 may have a permanently attached battery, circuitry, and light source. The light source may be a light emitting diode (LED) or other light-generating device. The battery may be soldered or otherwise permanently attached to the circuit board.

The illustrated embodiment 400 has four fingers 408, 410, 412, and 414 that may engage the slight protrusion 416 of bottle 402. The fingers 408, 410, 412, and 414 may be designed to slightly spring away when the bottle 402 is inserted into the embodiment 400. Alternatively, the fingers 408, 410, 412, and 414 may be designed so that the bottle 402, and specifically protrusion 416, deforms when inserted into embodiment 400.

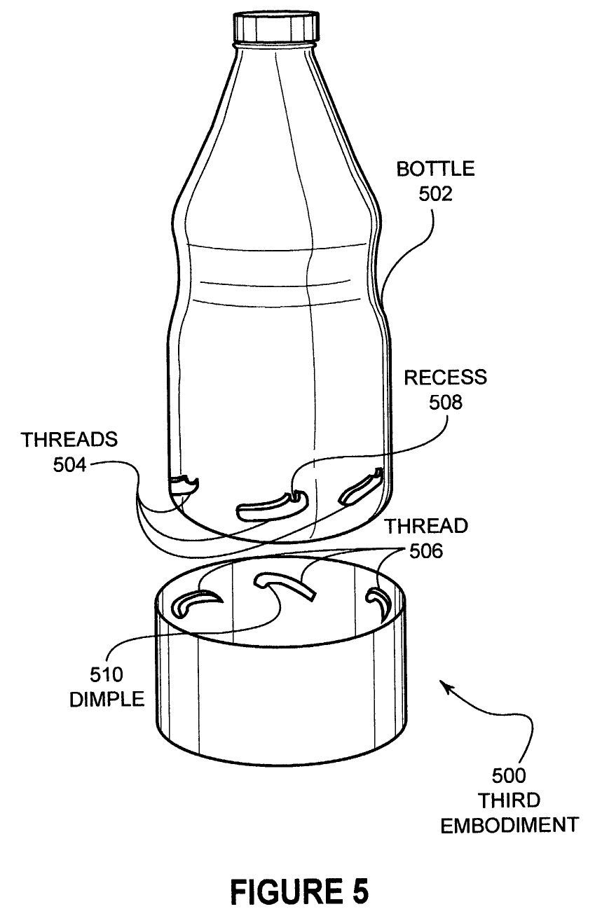

FIG. 5 illustrates an embodiment 500 of the present invention wherein bottle 502 attaches to embodiment 500 by twisting on a threaded portions 504 of bottle 502. Embodiment 500 has threaded portions 506 that engage portions 504 of bottle 502. The small recess 508 receives dimple 510 and serves as a locking element.

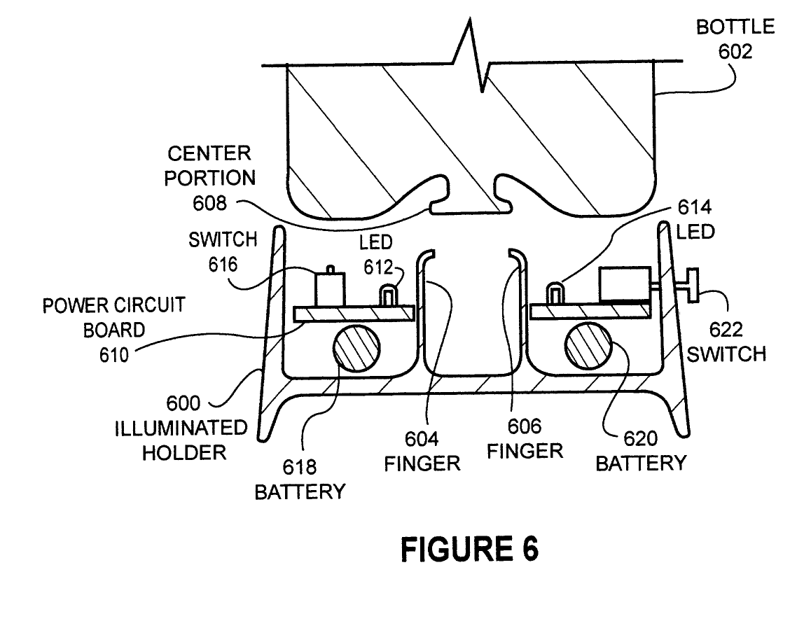

FIG. 6 illustrates a section view of an embodiment 600 of the present invention. Bottle 602 is shown prior to being attached to embodiment 600. Fingers 604 and 606 grasp the center portion 608 of bottle 602 to securely hold embodiment 600 to bottle 602. A printed circuit board 610 contains LED's 612 and 614. Switch 616 is mounted on printed circuit board 610 and is positioned such that the bottle 602 will contact switch 616 when bottle 602 is fully seated, thus enabling the circuit that illuminates the contents of bottle 602. Batteries 618 and 620 power the embodiment 600. Switch 622 protrudes to the outside of the embodiment 600. Switch 622 may be connected in series with switch 616 so that the embodiment 600 may not be operable until a bottle 602 is fully inserted and switch 622 are activated.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A device for the illumination at least a portion of the contents of a beverage container comprising:
a receiver adapted to attach to said beverage container and being further adapted to be removable; and
a light source, said light source comprising a battery, a switch, and a light bulb.

2. The device of claim 1 wherein said receiver further being adapted to attach to said beverage container by a snap action.

3. The device of claim 1 wherein said receiver further being adapted to attach to said beverage container by a motion comprising rotation about the longitudinal axis of said beverage container.

4. The device of claim 1 wherein said container comprises a concave portion into which at least a portion of said light bulb is located when said receiver is attached to said beverage container.

5. The device of claim 1 wherein said switch is activated when said receiver is fixedly attached to said container.

6. A device for the illumination at least a portion of the contents of a beverage container comprising:
a first means for removably attaching said device to said beverage container; and
a second means for illuminating at least a portion of the contents of said beverage container comprising an electrical circuit comprising at least one battery and at least one switch.

7. The device of claim 6 wherein said first means is adapted to attach to said beverage container by a snap action.

8. The device of claim 6 wherein said first means is adapted to attach to said beverage container by a motion comprising rotation about the longitudinal axis of said beverage container.

9. The device of claim 6 wherein said container comprises a concave portion into which at least a portion of said second means is located when said first means is attached to said beverage container.

10. The device of claim 6 wherein said switch is activated when said first means is fixedly attached to said beverage container.

11. The device of claim 6 wherein said second means comprises a laser.

12. A method of manufacturing a removable beverage illumination device comprising:
providing a receiver adapted to removably attach to a beverage container;
installing a battery into said receiver;
installing a light bulb into said receiver;
installing a switch into said receiver; and
providing electrical communication between said battery, said light bulb, and said switch such that the activation of said switch causes said light bulb to illuminate.

13. The method of claim 11 wherein said receiver is adapted to attach to said beverage container by a snap action.

14. The method of claim 11 wherein said receiver is adapted to attach to said beverage container by a motion comprising rotation about the longitudinal axis of said beverage container.

15. The method of claim 11 wherein said container comprises a concave portion into which at least a portion of said light bulb is located when said removable beverage container attachment means is attached to said beverage container.

16. The method of claim 11 wherein said switch is activated when said receiver is fixedly attached to said beverage container.
